(19) United States
(12) Patent Application Publication
(10) Pub. No.: US 2002/0077901 A1
(43) Pub. Date: Jun. 20, 2002

(54) Paired promotion architecture

(75) Inventor: Gary M. Katz, Northbrook, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Catalina Marketing International, Inc., St. Petersburg, FL

(21) Appl. No.: 09/828,122

(22) Filed: Apr. 9, 2001

Related U.S. Application Data
(60) Provisional application No. 60/256,324, filed on Dec. 19, 2000.

(51) Int. Cl. G06F 17/60

(52) U.S. Cl. 705/14; 705/36

(57) ABSTRACT

A novel method, system, and computer-readable medium that use a historical record of consumer behavior and/or demographic information relating to identify a more relevant promotion that is to be paired with a second low relevance product and/or product class. By pairing a more relevant promotion with a low relevance promotion, the consumer's attention can be captured and the likelihood that the low relevance promotion will be exercised increased.

### BACKGROUND OF THE INVENTION

1. Field of the Invention

This invention is directed toward effectively targeting promotions. More specifically, this invention is directed toward effectively targeting promotions by pairing delivered promotions to maximize the likelihood of exercise.

2. Discussion of the Background

Predictive targeting describes a marketing technique wherein marketing efforts are directed to an individual or group of individuals that have characteristics which indicate the likelihood of a certain behavior, such as a purchase and/or exercising a promotion. The examined characteristics of the individual or group commonly include a historical record of purchases and/or demographic data. By targeting marketing efforts to an individual or group considered to be likely to be interested in a product according to a predictive profile, the expense of marketing can be reduced and even small groups of individuals who are likely to be interested in a product can receive promotions regarding the product on a low cost per capita basis. A more complete description of predictive targeting and marketing is given, e.g., in “The Direct Marketing Handbook,” Edward L. Nash, ed., McGraw-Hill, N.Y., 1992, the entire contents of which are incorporated herein by reference, and in U.S. Pat. Nos. 6,026,370, 5,974,399, 5,892,827, 5,832,457, 5,612,868, 5,173,851, 4,910,672, 6,014,634, 6,055,573 the entire contents of all of which are incorporated herein by reference.

Since historical purchase records only indicate what a consumer has purchased in the past, promotions that are targeted using only purchase history will not effectively introduce a consumer to a new product and/or a new product class. For example, if a consumer has never purchased a product from the snack food product class (e.g., chips, pretzels, etc.), then a traditional practitioner of targeted marketing would most likely never provide a promotion for a product in this class to this a consumer. Rather, the traditional practioner of targeted marketing would likely confine the provision of promotions to those consumers who have purchased products in this class previously, greatly limiting the population pool that receives a promotion and the opportunity to grow this population pool. In other words, a traditional practitioner of targeted marketing would consider a promotion for a product in this product class to only be “low relevance,” or of marginal interest to the consumer and unlikely to be exercised. As such, there is no chance given to the possibility that a consumer might try a new product and/or product class.

Although a mass marketer might provide a “low relevance” promotion to such a consumer, the likelihood that such promotions would be exercised remains quite low, since, by definition, these promotions are mass distributed and must, e.g., catch the consumer's attention and convince the consumer of the desirability of a product purchase.

A similar problem exists with the introduction of a new product and/or product class. For example, with the technological development of new products and/or product classes, or when a vendor location starts carrying a new product and/or product class, there is no purchase history record for any consumers. In these cases, there is no information that a traditional practitioner of targeted marketing can use to identify a population for whom the promotion is likely to be “relevant.” The practitioner of targeted marketing who wishes to provide promotions is thus reduced to a mass marketer, randomly scattering promotions across a large population base, with very low promotion exercise rates and high distribution costs per promotion exercised.

### SUMMARY OF THE INVENTION

Accordingly, one object of this invention is to provide a novel method, system, and computer-readable medium for providing parameters that can be used to more effectively target promotions based on a historical record of consumer behavior and/or demographic information.

Another object of this invention is to provide a novel method, system, and computer-readable medium for providing parameters that can be used to more effectively target promotions based on a historical record of consumer behavior and/or demographic information, even when there is little or no historical record of consumer behavior and/or demographic information in regard to a particular product industry, product class, product type, and/or product.

A further object of this invention is to provide a novel method, system, and computer-readable medium for that provides parameters that can be used to predict consumer behavior based upon data collected with minimal effort by the consumer.

An object of one particular embodiment of this invention is to provide a novel method, system, and computer-readable medium for providing parameters that can be used to more effectively target promotions for a product in the packaged goods industry based on a historical record of consumer behavior and/or demographic information, even when there is little or no historical record of consumer behavior and/or demographic information in regard to a particular product class that contains the particular product.

An object of another particular embodiment of this invention is to provide a novel method, system, and computer-readable medium for providing parameters that can be used to more effectively target promotions for a product in the packaged goods industry based on a historical purchase record, even when there is little or no historical purchase record of a particular product class that contains the particular product.

These and other objects of the invention are realized by providing a novel method, system, and computer-readable medium that use a historical record of consumer behavior and/or demographic information relating to a first product and/or product class to identify a “more relevant” promotion that is to be “paired” with a second “low relevance” product and/or product class. By pairing a “more relevant” promotion with a “low relevance” promotion, the consumer's attention can be captured and the likelihood that the “low relevance” promotion will be exercised increased. In one embodiment, the product and/or product class is in the packaged good industry. In another embodiment, the “paired” promotions are printed on a single piece of paper. In another embodiment, the “paired” promotions are mailed in a single circular. In another embodiment, the “more relevant” promotion and the “low relevance” promotion relate to products that are produced by a same promoter. In another embodiment, the “more relevant” promotion and the “low relevance” promotion relate to products that are produced by different promoters. In another embodiment, the “more relevant” promotion and the “low relevance” promotion relate to products that are produced by different promoters, and the promoter with the “low relevance” promotion compensates the promoter with the “more relevant” promotion. In another embodiment, the relevancy of a promotion is determined based upon purchase history. In another embodiment, the relevancy of a promotion is determined based upon the number of times a product is purchased. In another embodiment, the relevancy of a promotion is determined based upon the number of times a product category is purchased. In another embodiment, the relevancy of a promotion is determined based upon the loyalty of a consumer to a brand (e.g., how often the consumer purchased a particular brand). In another embodiment, the relevancy of a promotion is determined based upon the volume of consumer purchases. In another embodiment, the relevancy of a promotion is determined based upon the frequency of consumer purchases. In another embodiment, the relevancy of a promotion is determined based upon the value (dollar or relative) of the promotion. In another embodiment, the relevancy of a promotion is determined based upon the location where the promotion can be exercised. In another embodiment, the pairing is performed to promote a product to a consumer who has never or only rarely purchased the product In another embodiment, the pairing is performed to promote a new product. In another embodiment, the pairing is performed to promote a product new to a location. Other embodiments entail the combination of one or more of any of the embodiments described above. For example, the relevancy of a product may be determined based on loyalty and the frequency of purchase.

As used herein, the term “promotion” refers to any offer, advertisement, incentive, coupon, and/or commercial for promoting one or more goods and/or services.

As used herein, to “exercise” a promotion refers to any redemption, consumption, employment, application, availment, and/or weilding of a promotion.

As used herein, the “relevancy” of a promotion refers to the likelihood that a promotion will be exercised.

As used herein, to “pair” promotions refers to any association of two or more promotions including printing together, requiring exercise together, displaying together, and/or showing together. Contrary to some common usages of the word “pairing,” the present invention is not limited to associating only two promotions. Thus, three or more promotions may be “paired.”

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 illustrates an exemplary network structure for pairing more relevant promotion(s) with low relevance promotion(s);

FIG. 2 illustrates an exemplary network structure for pairing more relevant promotion(s) with low relevance promotion(s);

FIG. 3a and 3b illustrate two exemplary data records for storing promotion selection and production data and consumer identification data;

FIGS. 4a and 4b illustrate two exemplary data records for storing exercised promotion data and consumer demographic data;

FIGS. 5a and 5b illustrate two exemplary data records for consumer purchase history data and analysis tool data;

FIG. 6 is a flow chart that illustrates an exemplary method for performing the present invention;

FIG. 7 is a flow chart that illustrates another exemplary method for performing the present invention;

FIG. 8 is a flow chart that illustrates a method for providing paired promotions by identifying consumers who are likely for find at least one promotion of the paired promotions more relevant;

FIG. 9 is a flow chart that illustrates another exemplary method for performing the present invention; and

FIG. 10 illustrates an exemplary computer system that can form several different units in an embodiment of the present invention.

### DETAILED DESCRIPTION OF THE PREFERRED EMBODIMENTS

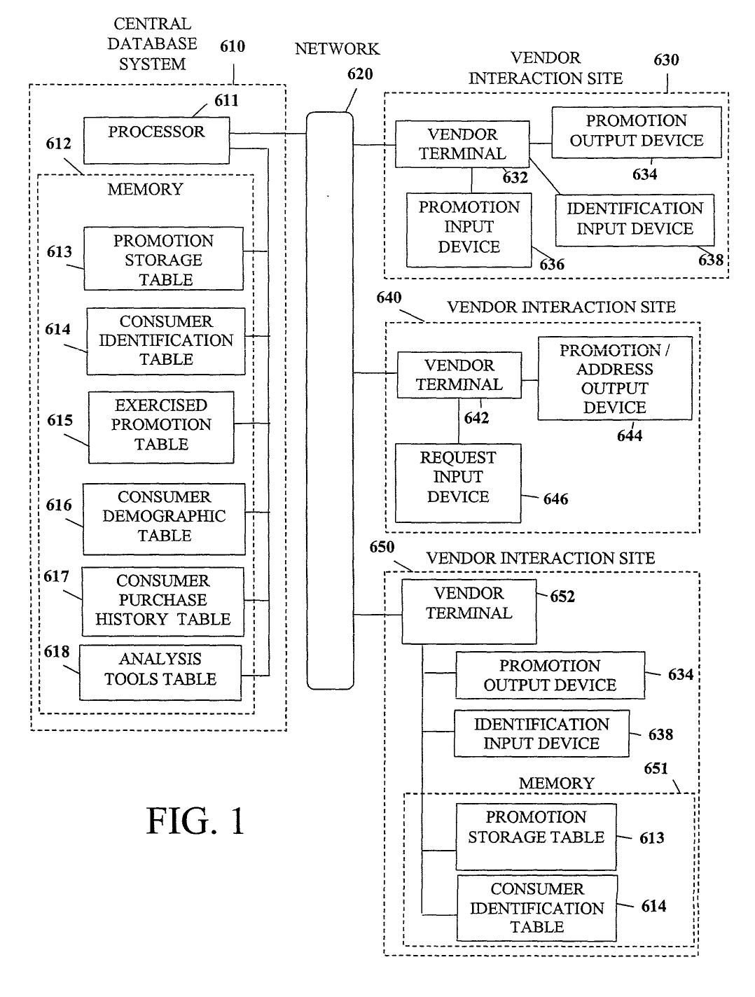

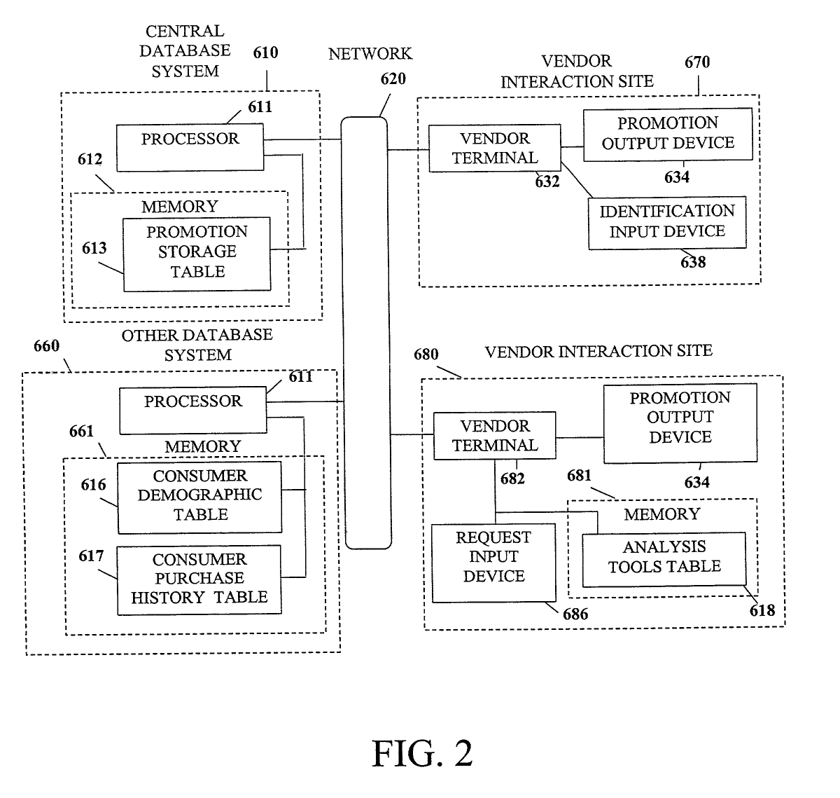

Referring now to the drawings, wherein like reference numerals designate identical or corresponding parts throughout the several views, and more particularly to FIGS. 1 and 2 thereof, which illustrate exemplary network structures for targeting promotions based upon a historical record of promotion usage. These network structures will include at least one vendor interaction site 630, 640, 650, 670, and/or 680 that is connected by way of a network 620 to a central database system 610. In alternate embodiments, network 620 can be dispensed with in whole or in part, and the one or more vendor interaction site 630, 640, 650, 670, and/or 680 can include the data and functionality herein attributed to the central database system 610. This is explicitly illustrated in vendor interaction site 650 of FIGS. 1 and 2 which contain a promotion storage table 613 and consumer identification table 614 and vendor interaction site 680 of FIG. 2 which contains an analysis tool table 618, also found in central database system 610 of FIG. 1. Thus, the network 620 can be implemented either as a communications or telecommunications network, or as an electrical lead, wire, or bus within a computer. As illustrated in FIG. 2, the central database system 610 of FIG. 1 can be divided into a plurality of database systems, such as central database system 610 and other database system 660 of FIG. 2, each directed to a subset of the data and functionality ascribed to the central database system 610 illustrated in FIG. 1. Furthermore, some embodiments of the network structure may include a vendor interaction site 650 which can combine some or all of the structures and/or functionality ascribed to central database system 610 with a vendor interaction site 630, 640, and/or 670. As illustrated in FIGS. 1 and 2, the vendor interaction site 650 is connected to the central database system by way of network 620. This is not necessarily the case, and the vendor interaction site 640 and the central database system 610 can be combined into one or more physically discrete units that may or may not be connected to a network.

The processor 611 of central database system 610 and other database system 660 is used for coding and decoding data transmitted over network 620, controlling reading and writing of data in tables 613, 614, 615, 616, 617, and 618, and analyzing the data in tables 613, 614, 615, 616, 617, and 618. The processor 611 (and vendor terminals 632, 642, 652, and 682) can be any processor configured for high volume data transmission and performing a significant number of mathematical calculations in processing communications (possibly as a webserver), database searches, and computational algorithms. A conventional personal computer or workstation with sufficient memory and processing capability may be configured to act as processor 611 (and vendor terminals 632, 642, 652, and 682). A PENTIUM III microprocessor such as the 1 GHz PENTIUM III for the SC 242 manufactured by Intel Inc., a Motorola 500 MHz POWERPC G4 processor, and the Advanced Micro Devices 1 GHz AMD ATHLON processor may all be used as the processor 611 (and vendor terminals 632, 642, 652, and 682). The tables 613, 614, 615, 616, 617, and 618 may reside or be stored on any suitable processor-accessible data medium, including but not limited to any type of disk including floppy disks, optical disks, CD-ROM, magneto-optical disks, ROMs, RAMs, EPROMs, EEPROMs, flash memory, magnetic or optical cards, or any type of media suitable for storing electronic data.

The network 620 may be a local area network, a wide area network (such as the Internet), a virtual private network, and/or a connection via a public switched telephone network. In an exemplary embodiment, the network 620 includes a number of connection modalities, including a cable-modem connection, a DSL connection, a dial-up modem connection, and/or other suitable connection mechanisms.

The first vendor interaction site 630 includes a vendor terminal 632 that would be located at, e.g., the check-out counter of a store, a vending machine, a central location shared by several stores, a mobile kiosk at a central location in a trade show, flea market, or street fair, an airline ticket counter, an entrance of a public accomodation such as a ballpark, nightclub, casino, or movie theater, a restaurant, a telephone where sales orders are placed, or even an individual's home computer in the case of Internet transactions. The vendor terminal 632 can be formed by a processor similar to processor 611, but in an exemplary embodiment it is simply dedicated to the reception and transmission of data over network 620 and the coding and decoding of data received from promotion input device 638, ID input device 638, and output to promotion output device 630b.

Vendor interaction site 630 is designed to be operated by the vendor and/or the potential customer. When the vendor interaction site 630 is placed at a position where the vendor can control the operation of the device (e.g., check-out counter, entrance to club or theater, airline ticket counter), the vendor is the party primarily responsible for the maintainence of the site. However, in certain transactions, such as in the case of Internet transactions, the vendor interaction site 630 may be physically removed from the vendor and owned/operated by, e.g., a consumer. Thus, an individual consumer's home personal computer can form a vendor interaction site 630, even though the vendor is not responsible for the site. Some locations of the vendor interaction site 630, such as at a mobile kiosk at a flea market or trade show, may include having a 3^{rd} party be responsible for the vendor interaction site 630.

In some embodiments, vendor interaction site 630 can include a promotion input device 636 such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving promotion identification information. One common example is a bar code reader that transduces barcodes on coupons at a supermarket check-out counter.

The exemplary vendor interaction sites 630 also includes an identification input device 638 that receives identification information from a consumer. In the exemplary vendor interaction site 630, the received identification information is forwarded to the central database system 610 where processor 611 compares it with previously stored information found in consumer identification table 614 to provide a confirmed identification of the consumer. Identification input device 638 can be any of a number of devices that receive and/or transduce identifying information regarding a consumer. Examples of embodiments of identification input device 638 that transduce identifying information include keyboards, touch screens, computer mouses, bar code readers, magnetic readers (including strip, disk, and tape readers), smart card readers, pressure sensors, motion detectors, electromagnetic receivers, voltmeters, heat sensors, voice transduction devices (e.g., microphones), digital cameras, fingerprint readers, iris recognition devices, genetic identification devices, and other transducers capable of transducing identification information regarding an individual and transferring this information to a digital processor. Examples of embodiments of identification input device 638 that receive identifying information without performing a transduction of a physical parameter include processors configured to receive digitized signals, images, sounds, patterns, and/or other information and analog-to-digital converters configured to convert analog signals, images, sounds, patterns, and/or other information into a digital format. Thus, the identification input device 638 of the vendor interaction site 630 need not conduct the actual transduction of the identification information, but rather identification input device 638 must simply be capable of receiving identification input from a consumer. One particular example of an identification input device 638 is a preferred customer card reader at a checkout counter in a supermarket.

Since the vendor interaction site 630 (including the identification input device 638) can be operated by a consumer and/or third party, the identification information can be a code or password provided by, e.g., a vendor for use by a particular customer. This can include, for example, a cookie placed on the consumer's home computer. Regardless of the nature of the identifying information, it is used to “identify” the consumer.

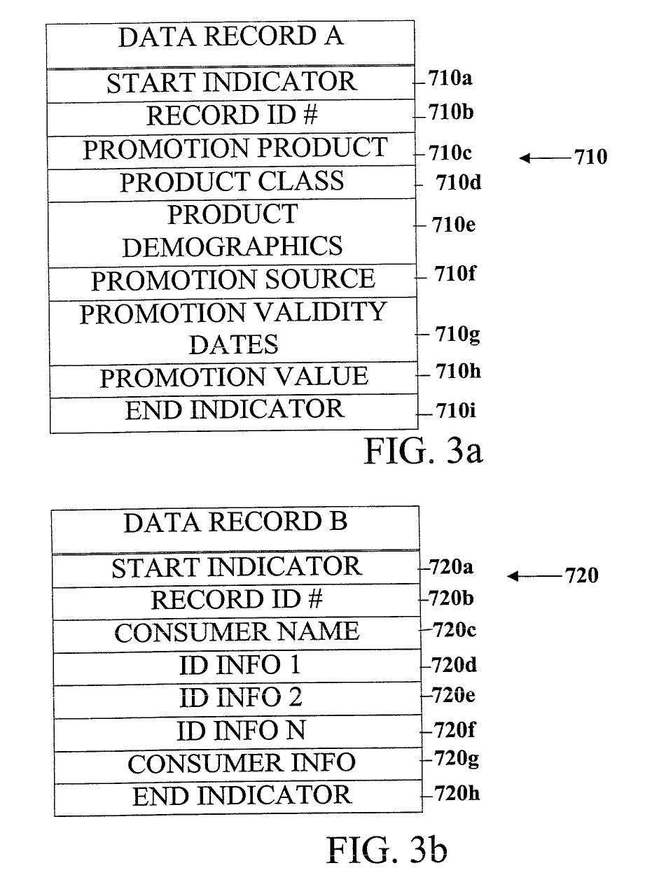

Regardless of the nature of identification input device 638, once identification data is transduced and/or received, it can be transferred from vendor terminal 632 to processor 611 of central database system 610. Naturally, this can be done by way of a network 620, or alternatively a processor similar to processor 611 can be part of vendor interaction site 630 (as shown in vendor interaction site 650). Regardless of the location of processor 611, the processor 611 can compare the received identification information to previously stored identification information found in consumer identification table 614 to determine the identity of the consumer. An exemplary data record that could be found in identification table 614 is illustrated as Data Record B 720 of FIG. 3b. Once the identity of the consumer has been determined , it can be used , e. g. ; to add data records to the exercised promotion table 615, to identify relevant records found in the consumer demographic table 616 or the consumer purchase history table 617, and/or to select and/or produce paired promotions using analysis tools table 618 in conjunction with promotion storage table 613.

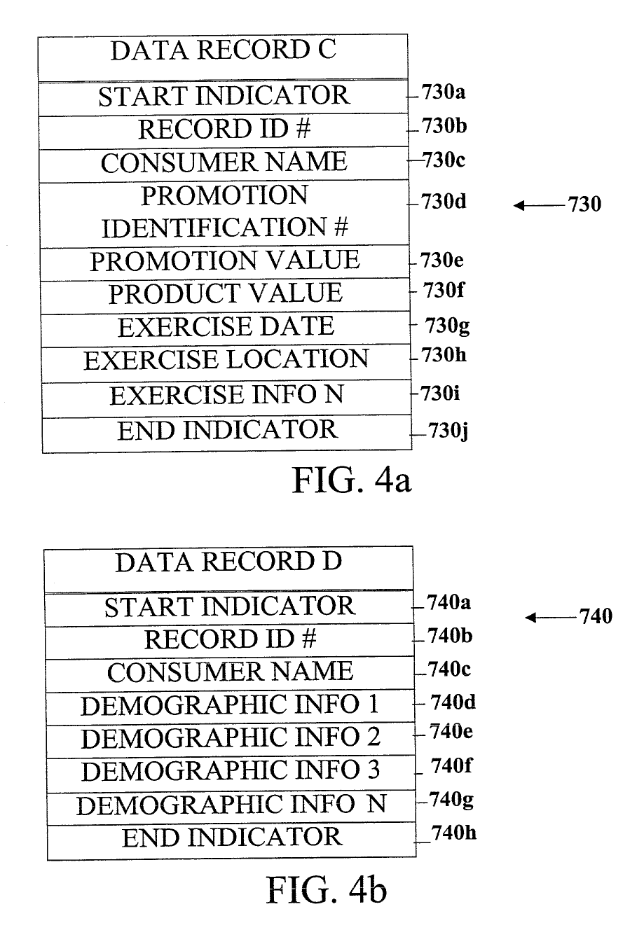

In some embodiments, a new record can be added to the exercised promotion table 615 once the identity of both the promotion and the consumer is available to the processor 611. This record can include information such as the price of the product for which the promotion is being exercised, the store in which the product is being exercised, the value of the promotion, and the number of other promotions exercised simultaneously with a particular promotion. An exemplary data structure of a record included in exercised promotion table 615 is illustrated in data record C 730 of FIG. 4a. Once processor 611 stores the information related to the exercise of one or more promotions in exercised promotion table 615, this information can accessed by processor 611 for analysis to determine, e.g., the relevancy of a promotion and/or to identify a more relevant promotion for a product and/or product class. This will be discussed in more detail later.

In some embodiments, the identity of the consumer can be used to locate a relevant record in consumer demographic table 616. Consumer demographic table 616 can contain data regarding the demographics of the individual consumer such as, e.g., age, profession, gender, race, education level, marital status, number of children, pet ownership, and other demographic factors. In one embodiment, this demographic information can be accessed by processor 611 for analysis to determine, e.g., the relevancy of a promotion and/or to identify a more relevant promotion for a product and/or product class. This will be discussed in more detail later. An exemplary data structure of a record included in consumer demographic table 616 is illustrated in data record D 740 of FIG. 4b.

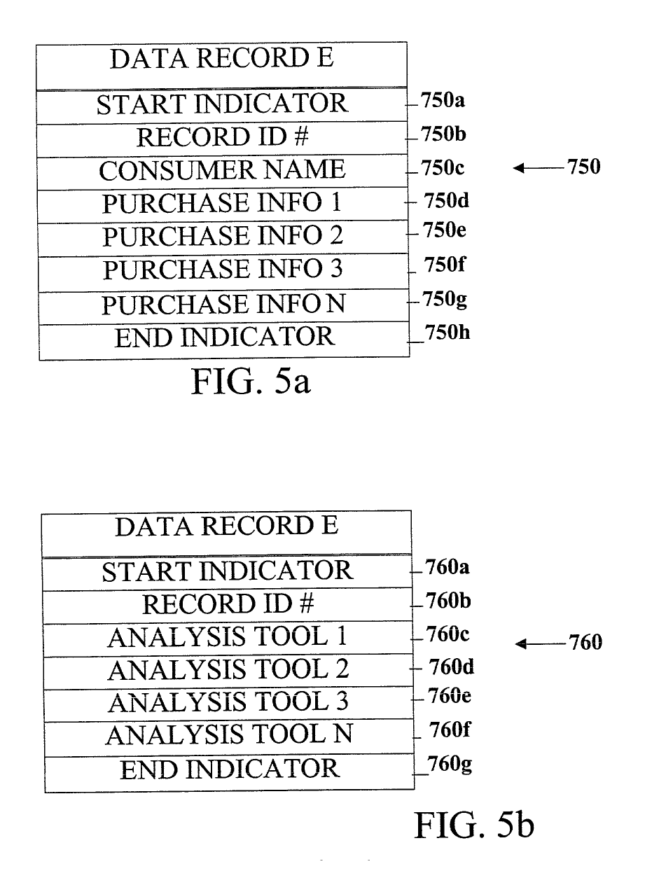

In some embodiments, the identity of the consumer can be used to locate a relevant record in consumer purchase history table 617. Consumer purchase history table 617 can contain data regarding the purchase history of the individual consumer such as, e.g., products previously purchased, the frequency of certain purchases, the name brands of certain purchases, the price of certain purchases (either in absolute terms or relevant to other available products), classes of products previously purchased, and locations where products are purchased. An exemplary data structure of a record included in consumer purchase history table 617 is illustrated in data record E 750 of FIG. 5a. Once processor 611 history table 617 can accessed by processor 611 to determine, in whole or in part, e.g., the relevancy of a promotion and/or to identify a more relevant promotion for a product and/or product class. This will be discussed in more detail later. Naturally, the consumer's demographic information in consumer purchase history table 617 can be combined with the consumer's demographic characteristics in consumer demographic table 616 and/or the consumer's promotion exercise record in exercised promotion table 615 to more accurately identify the relevancy of a promotion and/or a more relevant promotion.

In some embodiments, a variety of information regarding analysis tools is stored in analysis tools table 618 of central database system 610. Analysis tools table 618 can contain data regarding, e.g., weighting coefficients for certain demographic and/or purchase record information, methods for analyzing various types of data, methods for extracting various types of data, methods for filtering various types of data, and/or other information that may help a practitioners of predictive targeting to determine suitably paired promotions by determining, e.g., the relevancy of a promotion and/or to identify a more relevant promotion for a product and/or product class. Plural versions of analysis tool information can be stored to accommodate the preferences of different practitioners of predictive targeting, seasonal variations, product classes, consumer class, and/or other factors as so desired. An exemplary data structure of a record included in analysis tools table 618 is illustrated in data record F 760 of FIG. 5b. One or more specific analysis tool records can be selected from analysis tools table 618 by a practitioner of targeted marketing as desired, using, e.g., a vendor interaction site 640 as discussed below. As with, e.g., the data tables 613, 614, 616, 617, and 618, analysis tools table 618 need not be included in central database system 610, but can instead be located at a vendor interaction site 680 as illustrated in FIG. 2.

Promotion information that will allow the vendor and/or maintainer of the central database system 610 to determine the relevancy of a promotion, select a more relevant promotion, and/or provide paired promotions by way of the promotion output device 634 at the vendor terminal 630 is found in the promotion storage table 613. Information located in promotion storage table 613 can therefore include information that is used to determine the relevancy of a promotion (to a consumer that is, e.g., identified by identification input device 638) as well as to produce the promotion itself (as part of the pair) at promotion output device 634. The information necessary to produce a promotion can include the value of the promotion, a product to which the promotion relates, a barcode or other identifier to be included upon the promotion, and/or any image or other packaging information related to the promotion. As mentioned above, if the promotion storage table 613 is located at the vendor interaction site (as explicitly illustrated in vendor interaction site 650), the information necessary to produce a promotion need not be transmitted over network 620 to central database system 610. An exemplary data record that could be found in promotion storage table 613 is illustrated as Data Record A 710 of FIG. 3a.

Information related to two or more paired promotion or for determining two or more paired promotions can be selected from promotion storage table 613 by one of the analysis tools found in analysis tools table 618, and forwarded to vendor interaction site 630 by way of network 620 as desired. After the information is received at vendor interaction site 630, the paired promotions can be output using promotion output device 634. Promotion output device 634 can be any of a number of different devices, including a computer monitor, printers (paper or otherwise), magnetic writing devices (including disk drives, magnetic strip writers, tape writers), bar code writers, smart card writers, television screens, radio broadcast, Internet data transmission, print advertisement in a newspaper or newsletter, or simply electronic confirmations communicated automatically to another device, such as, for example, a check-out register or a credit card billing machine. In one embodiment, the promotion output device 634 prints a pair of coupons upon a single piece of paper immediately after an identified consumer checks out at a supermarket cashier register. In general, the promotion output device 634 somehow pairs or associates one or more more relevant promotion(s) with one or more low relevance promotion(s).

Paired promotions need not be output at the same vendor interaction site 630 (and/or simultaneously) where consumer identification and/or promotion information is received. This is illustrated explicitly by vendor interaction site 640, which shows a vendor interaction site without either a promotion or an identification input device. Rather, vendor interaction site 630 simply contains a request input device 646, through which a vendor wishing to practice predictive targeting can request the identification of paired promotions for a consumer and/or a suitable consumer for particular paired promotions. This request is transmitted by processor 642 through network 620 to central database system 610, where information relating to the paired promotions and/or a suitable consumer for the particular paired promotions is identified, and returned to processor 642. Upon receipt of the information at processor 642, information relating to the paired promotions and/or consumer is transmitted to promotion/address output device 644. If the request input at request input device 646 was for a consumer suitable for certain paired promotion, then promotion/address output device 644 will output an address label, email address, and/or other information and/or item that insures that the particular paired promotions will be delivered to a suitable consumer. If the request input at request input device 646 was for paired promotions for a certain customer, then promotion/address output device 644 will output the determined paired promotions for the consumer.

Request input device 646 can be a device such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving request information. Promotion/address output device 644 can be any of a number of different devices, including a computer monitor, printers (paper or otherwise), magnetic writing devices (including disk drives, magnetic strip writers, tape writers), bar code writers, smart card writers, television screens, radio broadcast, Internet data transmission, print advertisement in a newspaper or newsletter, or simply electronic confirmations communicated automatically to another device, such as, for example, a check-out register or a credit card billing machine. In one embodiment, request input device 646 is a computer keyboard operated by a practitioner of targeted marketing, and promotion/address output device 644 is a address label printer used to provide a mail address to a suitable promotion.

Vendor interaction site 650, in addition to containing both a promotion output device 634 and an identification input device 638, also contains promotion storage table 613 and consumer identification table 614. This type of interaction site can be operated in conjunction with a central database system 610 as illustrated in FIG. 1, or with a central database system 610 as illustrated in FIG. 2. For example, the promotion storage table 613 could be dedicated to promotions that are valid only at the owner and/or operator of vendor interaction site 650, and the consumer identification table 614 could be dedicated to consumer identification information that is recognized only by the owner and/or operator of vendor interaction site 650. For example, if vendor interaction site 650 were owned and/or operated by a supermarket, “in-store” coupon selection and production information could be stored at promotion storage table 613 of vendor interaction site 650, and identification information relevant to that supermarket's (or supermarket chain's) frequent customer cards could be stored at consumer identification table 614 of vendor interaction site 650. However, if one or more promotions to be included in a pair is not particular to a specific vendor interaction site 650, e.g., a manufacturer's coupon, or other identifying information such as a credit card is presented by the consumer, then vendor terminal 652 could access promotion storage table 613 and consumer identification table 614 central database system 610 to select and/or produce paired promotions and/or identify a consumer. Vendor interaction site 650 can also include a promotion input device (not shown), as discussed in regard to vendor interaction site 630.

Turning now specifically to FIG. 2, which shows further exemplary components of a network structure according to the present invention, these elements being used alone or in conjunction with the network structure shown in FIG. 1, the central database system 610 of FIG. 2 has been pared down to a promotion storage table 613. In this case, some or all of the functionality previously ascribed to the central database system 610 of FIG. 1 can be transferred in whole or in part to one or more components. For example, the other database system 660 now contains consumer demographic table 616 and consumer purchase history table 617. The other database system 660 can be owned and/or operated by, e.g., a third party and/or a practitioner of targeted marketing. In this way, a practitioner of targeted marketing can use other demographic and/or historical purchase information to target promotions. This is especially relevant to a practitioner of targeted marketing who is using proprietary demographic and/or consumer purchase history information, such as that collected by the vendor itself, to determine one or more promotions to be included in the paired promotions provided to the consumer.

Also illustrated in FIG. 2 is a vendor identification site 670 that does not include a promotion input device 636. The lack of a promotion input device 636 is intended to explicitly illustrate that no promotion need be used in order for a practitioner of targeted marketing to provide a promotion to a consumer. Any time that a consumer is identified using identification input device 638, paired targeted promotions can be output at promotion output device 634. This embodiment of vendor identification site 630 is particularly useful for small vendors that manually enter promotions, for vendors where promotions are not common and/or accepted (such as, e.g., physician's offices, legal offices, etc.), or when the vendor interaction site 630 is not used to conduct an actual purchase transaction, such as a vendor interaction site 630 that is formed by an individual's home computer.

Vendor interaction site 680 of FIG. 2 includes an analysis tools table 618 such as found at the central database system 610 of FIG. 1. The analysis tools table 618 at vendor interaction site 680 allows a vendor to develop and store individualized and/or proprietary analysis tools. Thus, data drawn from, e.g., an exercised promotion table 615, consumer demographic table 616, and/or consumer purchase history table 617 can be transmitted over network 640 in response to a request from the vendor terminal 682 of vendor interaction site 680 and analyzed at the same vendor terminal 682 using analysis tools stored in analysis tools table 618. This allows a practitioner of predictive targeting to maintain control over the analysis tools and/or results of analysis.

FIG. 3a and 3b illustrate two different data record structures 710 and 720 that may be used in promotion storage table 613 and consumer identification table 614 of FIGS. 1 and 2. The promotion product field 710c of promotion record 710 identifies the promoted product to either the analysis tools stored in analysis tools table 618 or the promotion output device 634 (and/or the promotion/address output device 644) during production of the promotion. The product class field 710d of promotion record 710 identifies the class(es) of the product identified in promotion product field 710c. Exemplary product classes include ethnic classes, health (e.g., diet/non-diet, fat/low fat) classes, religious (e.g., kosher/non-kosher) classes, food type (e.g., snack/non-snack), classes related to preparation characteristics (e.g., preparation time, utensils, seasons), demographic (e.g., child/adult, dog owner/no dog) classes, and or other classes and/or denominations that can be used to classify a product. The product class field 710d of promotion record 710 identifies the promoted product class to the analysis tools stored in analysis tools table 618, which, in conjunction with demographic, purchase history, and/or promotion exercise information stored in data tables 615, 616, and 617, determine the relevancy of particular promotions. The product demographics field 710e of promotion record 710 identifies demographic information of the promoted product identified in promotion product field 710c. This information can include information related to the age, profession, gender, race, education level, marital status, number of children, pet ownership, and other demographic factors of consumers to whom the product identified in promotion product field 710c is likely to be relevant. The promotion source field 710f of promotion record 710 identifies the promoter of the product identified in promotion product field 710c. The promoter can include, e.g., the manufacturer and/or supermarket that is providing an in-store promotion for the product identified in promotion product field 710c, and this information can be used to produce the promotion as part of the paired promotions at promotion output device 634 (and/or device 644). The promotion validity dates field 710g of promotion record 710 identifies the validity date of the promotion, and this information can be used to produce a promotion as part of the paired promotions at promotion output device 634. The promotion value field 710h of promotion record 710 identifies the value (in absolute terms or relative to the price of the product) of the promotion, and t his information can be used to produce a promotion as part of the paired promotions at promotion output device 634.

Consumer identification record 720 is used to identify a consumer using information input at, e.g., identification input device 638. One or more identification factors input at an identification input device 638 can be compared to identification factor records 720d, 720e, and 720f to determine or confirm the identity of the individual identified in consumer name field 720c. When identity is being confirmed, the relevant consumer identification record 720 is first located using consumer name field 720c, but when identity is being determined, the relevant consumer identification record 720 is first located using identification factor records 720d, 720e, and 720f to locate a match or a near match. Regardless of whether a confirmation or determination is performed, after it has been completed, a consumer will be identified. Consumer information field 720g is optional and may include information related to the consumer such as, e.g., the address of the consumer, the location of further demographic and/or consumer purchase history related to the consumer or even the demographic and/or consumer purchase history information itself.

FIGS. 4a and 4b illustrate two different data record structures 730 and 740 that may be used to store data regarding exercised promotions in exercised promotion table 615 and data regarding a particular consumer's demographic information in consumer demographic tables 616 of FIGS. 1 and 2. Exercised promotion record 730 is used to store information related to the promotions that a consumer has exercised. The consumer's name is stored in field 730c, and exercised promotion identification information such as a promotion identification number is stored in field 730d. Field 730e stores the value of the exercised promotion identified in field 730d. Field 730f of exercised promotion record 730 is used to store the product value at time of use. This is desirable since a promotion may be denominated in absolute terms, whereas an analysis tool may require the promotion value in relative (% of total cost) terms. Field 730g describes the date that the promotion was exercised to allow a practitioner of predictive targeting to monitor the frequency and/or change in frequency of promotion use. Field 730h describes the location where a promotion is used, so that a practitioner of predictive targeting can monitor the patterns in location of promotional usage. This is relevant since, e.g., a consumer may exercise promotions more extensively at certain types or locations of stores more often than at others, and this can be used to increase a predictive targeting practitioner's accuracy in determining the likelihood that a particular promotion will be exercised. Further usage information N can be stored in field 730i. This further usage information may be related to, e.g., the number of promotions used simultaneously, an estimated time required for the consumer to exercise the promotion, a broad class of goods and/or services into which the product falls, and/or other factors related to exercises promotions.

Consumer demographic record 740 is used to store information related to the demographics of a consumer. The consumer's name is stored in field 740c and various demographic information is stored in fields 740d, 740e, 740f, and 740g. This demographic information can relate to, e.g., a consumer's age, profession, gender, race, education level, marital status, number of children, pet ownership, and other demographic factors.

FIGS. 5a and 5b illustrate two different data record structures 750 and 760 that may be used to store data regarding a consumer's purchase history in purchase history table 616 and data regarding one or more analysis tools in analysis tools tables 618 of FIGS. 1 and 2. Consumer purchase history 750 is used to store information related to past purchases by the consumer, regardless of promotion usage. The consumer's name is stored in field 750c, and purchase information such as a product purchased, amount purchased, frequency of purchases, time of purchase, similar purchases in a same product category, class, and/or industry, product price, date of purchase, location of purchase, and/or other purchase history information is stored in fields 750d, 750e, 750f, and 750g.

Analysis tools record 760 is used to store information in an analysis tools table 618 as illustrated in FIGS. 1 and 2. This information is related to one or more analysis tools for use by a practitioner of predictive targeting to determine the relevancy of promotions to be paired, and/or to select a particular consumer that will be targeted by predetermined paired promotions. Fields 760c, 760d, 760e, and 760f of analysis tools record 760 contain, e.g, computer processor instructions and/or other information needed to perform an analysis of the data stored in records 730, 740, 750, and/or even 720 to determine the relevancy of a promotion to a consumer. For example, instructions contained in analysis tools record 760 can be used to determine the relevancy of promotions for certain products and/or product classes described by field 710d and/or demographics characteristics described by field 710e of promotion storage record 710 with consumers having certain demographic characteristics stored in table 740, promotion usage characteristics as stored in table 730, and/or purchase history characteristics as stored in table 750. When a promoter wishes to provide a promotion that, according to traditional indicators, is only of low relevance to the consumer, the computer processor instructions and/or other information of analysis tools record 760 can be used to identify a promotion of high relevance to the same consumer so that the two promotions can be paired, and the likelihood that the low relevance promotion be exercised increased. Likwise, when a predetermined pair of promotions exists, then the computer processor instructions and/or other information of analysis tools record 760 can be used to identify a consumer for which one promotion of the pair is more relevant, and the other promotion of the pair is of low (or unknown) relevance.

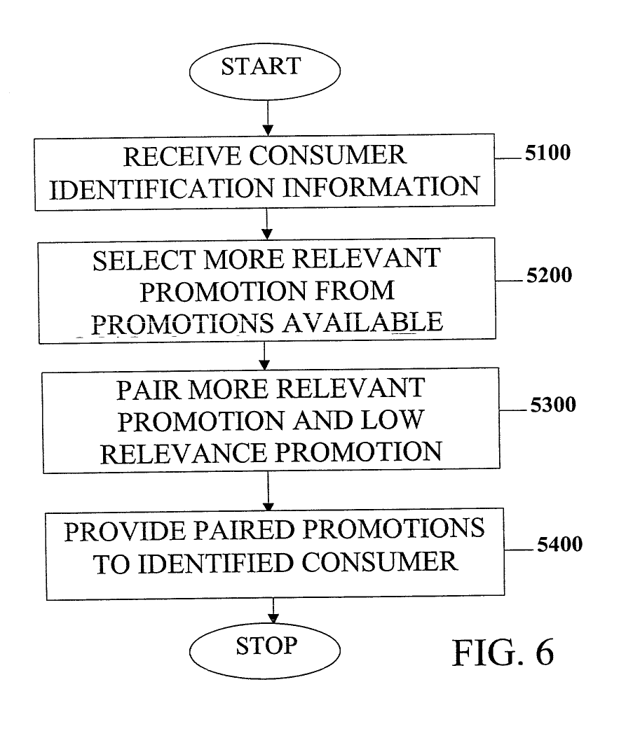

FIG. 6 is a flow chart that illustrates an exemplary method for performing the present invention. In this exemplary method, a single low relevance promotion drives the selection of a more relevant promotion to which it is to be paired. This method is particularly appropriate for promoting products in product classes and/or product industries that are “new” in the sense that the consumer has not purchased the product class and/or product industry before, in the sense that a particular store location has not carried a product class and/or product industry before, and/or in the sense that the product class and/or product industry itself is new. In each of these cases, there is little or no data extant for identifying consumers for whom a promotion related to a particular product is relevant. In fact, there might even be data that indicate that a promotion related to a particular product is not relevant to a consumer, in the case where the consumer has previously by-passed opportunities (such as promotions) to purchase a particular product. However, by pairing such a low or low relevance promotion with a more relevant promotion, the exercise rate of the low relevance promotion can be increased.

Thus, there are many reasons why a promoter might wish to provide low relevance promotions to consumers. For example, the product promoted by the low relevance promotion might have a high profit margin, be new to the geographic location, or be a new technological development. Furthermore, the promoted product might represent a foray into a new industry for the promoter, or the product may have recently suffered from lower sales and the promoter is seeking new customers. In each of these cases, the promoter starts with a promotion that is of low relevance to to one or more consumers.

In one exemplary embodiment, the determination of the relevance of a promotion is made by examining a consumer's purchase history record for a line of products from a single promoter (e.g., Kraft cheeses, Post breakfast cereal). For example, suppose that a single promoter produces 14 product lines. Once every (or almost every) product that a promoter sells has been assigned to a promoter product line, the purchase history of the consumer can be examined to determine the number of purchases that the consumer has made of the promoter's products in each particular product line. The various product categories can then be ranked based upon a frequency (number) of purchases in each promoter product line. An arbitrary cut-off can then be used to classify each of the promoter product lines as “more relevant” or “low relevance.” For example, since there are 14 product lines that describe a promoter's product arsenal, the seven promoter product lines that have the largest number of purchases by the consumer can be deemed “more relevant,” whereas the seven promoter product lines that have the lowest number of purchases by the consumer can be deemed “low relevance.” Based upon this classification, if the promoter wishes to enhance the likelihood that a promotion relating to a product that is classified in a “low relevance” promoter product category is exercised, this promotion can be paired with a second promotion that relates to a product that is classified in a more relevant promoter product line. This particular embodiment is particularly useful in that the determination of the relevance of a promotion is fairly simple, and that both the low relevance and the more relevant promotion is provided by the same promoter. Since promotions represent a cost to the promoter, this facilitates the provision of more relevant promotion and removes the need to compensate a second promoter for the more relevant promotion.

In another exemplary embodiment, the determination of the relevance of a promotion is made by examining the frequency of a consumer's purchases for products of a certain class from a single promoter relative to the total frequency of the consumer's purchases for products of that class (i.e., including both the promoter's products as well as other promoter's products). This approach gives an indication of what is commonly termed the “loyalty” of a particular consumer to the promoter's products. The loyalty of a consumer can also be used to determine the relevancy of a promotion. For example, consider the case of a promotion that relates to a particular brand of ice cream (e.g., Ben and Jerry's ice cream). Using the loyalty approach, such a promotion would be deemed more relevant to a consumer who only rarely purchases ice cream but always purchases the particular brand of ice cream (e.g., Ben and Jerry's). However, also under this loyalty approach, such a promotion would be deemed of low relevance to a consumer who purchases ice cream quite often, but only rarely or never has purchased the particular brand of ice cream (e.g., Ben and Jerry's). This approach thus allows for the pairing of promotions based at least in part upon a consumer's loyalty to a particular brand.

In another exemplary embodiment, the determination of the relevance of a promotion is made by examining the category purchase history of the consumer. Category purchase history, as used herein, indicates the total purchase history of the consumer within a particular category, whether or not the products originate with a particular promoter. Exemplary categories include, e.g.: ethnic food product categories, such a Mexican, French, or California cuisine; age-related food product categories, such as baby food; health food product categories, such as diet food, lactose-intolerant food; and religious food product categories, such as specialized Kosher products. The use of category purchase history to determine the relevancy of a promotion to a consumer allows the promoter to consider the entirety of a consumer's purchase history, rather than just isolated facets of the purchase history. For example, if a consumer has never before purchased Taco Bell-brand salsa, but often purchases other products that are classified in a “Mexican food category,” then both the loyalty-based approach and the product line approach described above will indicate that promotions for Taco Bell-brand Salsa are of low relevance to the consumer. However, by examining the category purchase history of the consumer, such promotions are seen as highly relevant, since the consumer has often purchased products in the Mexican food category before. Thus the entirety of the consumer's purchase history can be examined, and a single promoter can provide both the more relevant and the low relevance promotion if necessary.

In another exemplary embodiment, the determination of the relevance of a promotion is made by examining the promotion usage history of the consumer. A “promotion usage denominator” that relates to, e.g., the products for which promotions are exercised, the value (relative or absolute) of promotions that are exercised, and/or location where promotions are exercised can be used to determine the relevancy of a promotion to the consumer. For example, if a consumer rarely exercises promotions that are worth less than 10% of the dollar cost of the product, than such promotions can be classified as of low relevance to the consumer.

Likewise, in another exemplary embodiment, a determination of the relevance of a promotion can be made by examining the demographic characteristics of a consumer. For example, a promotion that promotes diapers would be deemed more relevant to a consumer with infant children, whereas it would be deemed less relevant to a consumer without infant children. One advantage of such determinations based on demographics is that they can be made using relatively small amounts data, since an extensive database of consumer purchases need not be maintained.

Naturally, a determination of the relevance of a promotion can be made based on other factors as well as these factors in combination with each other or other factors, in accordance with the present invention.

In regard to FIG. 6, in step 5100, identification information is received from a consumer to whom the inital promotion is only low relevance. This information could be received using, e.g., an identification input device 638 as illustrated in FIGS. 1 and 2.

In step 5200, a more relevant promotion is selected from promotion storage table 613 based upon the purchase history characteristics (stored, e.g., in table 615), consumer demographic characteristics (stored, e.g., in table 616), and/or exercised promotion characteristics (stored, e.g., in table 617) of the consumer identified in step 5100. This can be done in conjunction with the class, demographic, and/or exercise location information related to various promotions stored in, e.g., field 710d, 710e, and 710g of plural data records 710.

In step 5300, the more relevant promotion selected in step 5200 is paired with the low relevance promotion that the promoter wishes to provide to the consumer. As described above, “pairing” can indicate printing both the more relevant promotion and the low relevance promotion on a same piece of paper at, e.g., a promotion output device 634. “Pairing” can also indicate, e.g., displaying the promotions together on a single display.

In step 5400, the paired promotions are provided to the consumer identified in step 5100. This can be done, e.g., using a promotion output device 634 described in FIGS. 1 and 2. Naturally, step 5400 need not be performed by the same entity who performs steps 5200 and/or 5300. Rather, only information used to perform step 5400 need be provided.

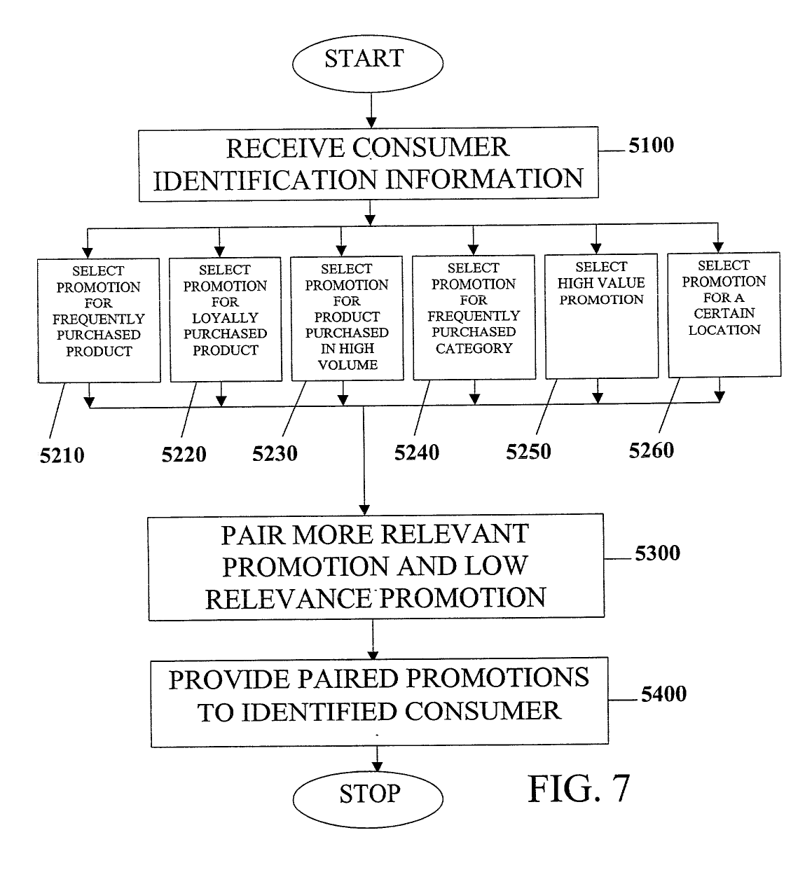

FIG. 7 is a flow chart that illustrates another exemplary method for performing the present invention where a single low relevance promotion drives the selection of a more relevant promotion to which it is to be paired. In FIG. 7, specific, more effective consumer characteristics are used to select more relevant promotions. These are illustrated in parallel as steps 5210, 5220, 5230, 5240, 5250, and 5260 in FIG. 7, each of these consumer characteristics can also be used alone, in series, or in some combination of in parallel and in series in accordance with the present invention. Thus, the illustrated parallel process flow in FIG. 7 is for illustrative purposes only, and should not be considered as limiting the present invention.

In step 5210, a more relevant promotion is selected from, e.g., promotion storage table 613 based at least in part upon frequently purchased products, as determined from the examination of plural records 750 from consumer purchase history table 617 using one or more analysis tools from analysis tools table 618. The use of a more relevant promotion directed to a frequently purchased product is particularly effective for pairing with a low relevance promotion since the consumer is very likely to be able to retain and/or remember the more relevant promotion, as well as any low relevance promotion paired thereto in step 5300, until the next purchase.

In step 5220, a more relevant promotion is selected from, e.g., promotion storage table 613 based at least in part upon consumer loyalty to a product, as determined from the examination of plural records 750 from consumer purchase history table 617 using one or more analysis tools from analysis tools table 618. Consumer loyalty can be determined by comparing how often a consumer purchases a particular brand of product with the total number of purchases by the consumer of that product and/or product class. For example, if a consumer always purchases POST RAISIN BRAND cereal every time that the consumer purchases any breakfast cereal, then the consumer is loyal to this product even if the total frequency of breakfast cereal purchases is low. The use of a more relevant promotion directed to a product to which the consumer is loyal is particularly effective for pairing with a low relevance promotion since the consumer's attention is immediately directed to the more relevant promotion, and the consumer immediately recognizes the more relevant promotion as valuable. As such, the consumer is more likely to examine and exercise the low relevance promotion paired thereto in step 5300.

In step 5230, a more relevant promotion is selected from, e.g., promotion storage table 613 based at least in part upon consumer purchase of a product in high volume, as determined from the examination of plural records 750 from consumer purchase history table 617 using one or more analysis tools from analysis tools table 618. The use of a more relevant promotion directed to a product which the consumer purchase in high volume is particularly effective for pairing with a low relevance promotion since the consumer recognizes the more relevant promotion as directed to a product which the consumer needs in relatively high volume. As such, the consumer is more likely to examine and exercise the low relevance promotion paired thereto in step 5300.

In step 5240, a more relevant promotion is selected from, e.g., promotion storage table 613 based at least in part upon frequent consumer purchase of a product category, as determined from the examination of plural records 750 from consumer purchase history table 617 using one or more analysis tools from analysis tools table 618. The use of a more relevant promotion directed to a product in a category which the consumer frequently purchases is particularly effective for pairing with a low relevance promotion since this expands the possibilities for a single promoter to provide both the more relevant promotion and the low relevance promotion. In the examples described above in steps 5210, 5220, and 5230, the more relevant promotion is limited to a product that the consumer already purchases. Naturally, the promoter who wishes to target a low relevance promotion may not have the authority to distribute promotions for those products that the consumer already purchases. For example, Kellogg's might not be authorized to provide a promotion directed to POST RAISIN BRAND cereal, even though the consumer is loyal to this product (and/or has frequently purchased this product, or has purchased this product in high volume). Therefore, by pairing a more relevant promotion directed to a product in a category which the consumer frequently purchases with a low relevance promotion, the promoter is able to achieve all of the above-described advantages, even though the consumer may never have previously purchased the product promoted by the more relevant promotion. This is particularly favorable since the burden of providing a more relevant promotion now falls directly upon the promoter of the low relevance promotion. In other words, since the consumer is likely to purchase the product promoted by the more relevant promotion even in the absence of a promotion, the provision of a more relevant promotion is essentially an unnecessary expense when considered only in light of the product promoted by the more relevant promotion. However, since the provider of the more relevant promotion is now the same promoter that wishes to provide the low relevance promotion, a broader view of the expense related to the provision of a more relevant promotion is possible.

In step 5250, a high value promotion is selected from, e.g., promotion storage table 613 based at least in part upon the value of past promotions exercised, as determined from the examination of plural records 730 from exercised promotion table 615 using one or more analysis tools from analysis tools table 618. The use of a high value promotion as a more relevant promotion is particularly effective for pairing with a low relevance promotion since the consumer has already displayed a propensity for exercising promotions of this type. Thus, the high value promotion is very likely to be worth the consumer's time and attention, and the consumer is likely to retain and/or exercise both the more relevant promotion and the low relevance promotion.

In step 5260, a promotion exercisable at a certain location is selected from, e.g., promotion storage table 613 based at least in part upon the value of past promotions exercised, as determined from the examination of plural records 730 from exercised promotion table 615 using one or more analysis tools from analysis tools table 618. The use of a promotion exercisable at a certain location as a more relevant promotion is particularly effective for pairing with a low relevance promotion since the more relevant promotion can be chosen such that the consumer has already displayed a propensity for exercising promotions at the relevant location. Thus, the promotion exercisable at a certain location is likely to be convenient for the consumer, and the consumer is likely to retain and/or exercise both the more relevant promotion and the low relevance promotion.

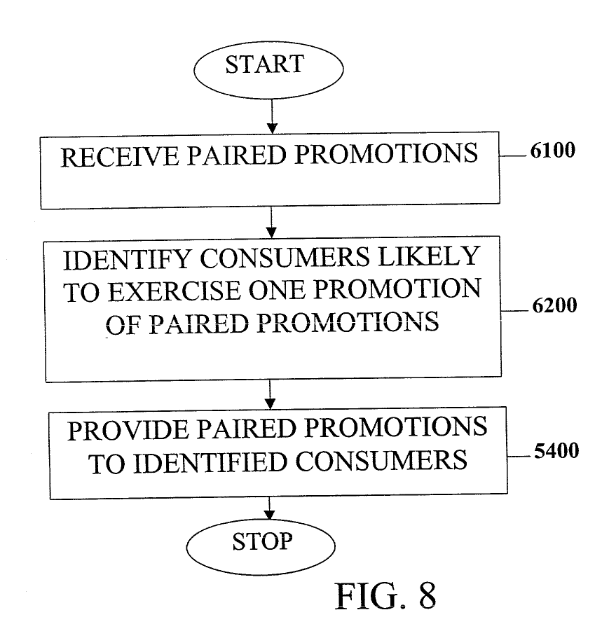

FIG. 8 is a flow chart that illustrates an exemplary method for performing the present invention. This method is unique in that predetermined paired promotions are provided to, e.g., a practitioner of this method. This type of process is flow is particularly useful when, e.g., a single promoter wishes to leverage the success o f a more relevant product to a less relevant product. This may happen when, e.g., a single promoter introduces a new product line, and/or enters a new product category. Also, this method may be used when two or more promoters join together to leverage their individual paired products. For example, a snack food company may pair with a breakfast cereal company, so that each company may, in turn, provide the more relevant promotion and the low relevance promotion to consumers, sharing the above-described burden of providing the more relevant promotion.

Alternatively, one promoter can compensate the other for the rights to be paired to the other's more relevant promotion, or a practitioner of the present invention can pair promotions independent of the promoters and, when the practitioner is paid on a “per hit” (i.e., per promotion exercised) basis, the practitioner can receive a higher fee.

In step 6100, information describing the predetermined paired promotions is received by the practitioner of the invention. This includes the information necessary to determine the relevancy of the paired promotions to particular consumers, and may also relate the information necesary to provide the paired promotions to a consumer.

In step 6200, consumers who are likely to regard at least one of the paired promotions as low relevance and at least one of the paired promotions as more relevant are identified. This can be done by comparing the information regarding the paired promotions received in step 6100 with information about individual consumers stored in, e.g., tables 615, 616, and 617. As described above, more than one invention can be “paired.” As the ratio of more relevant promotions to low relevance promotions increases, so does the likelihood that low relevance promotions will be exercised. Any of the individual consumer characteristics described in steps 5210, 5220, 5230, 5240, 5250, and 5260 in FIG. 7 can be used to identify the consumers who are likely to regard at least one of the paired promotions as low relevance and at least one of the paired promotions as more relevant in step 6200.

In step 5400 of FIG. 8, the paired promotions are provided to the identified consumers. This step can likewise include identifying the likely exercisers to those who wish to provide the paired promotions by, e.g., printing out mailing labels on the promotion/address output device 644.

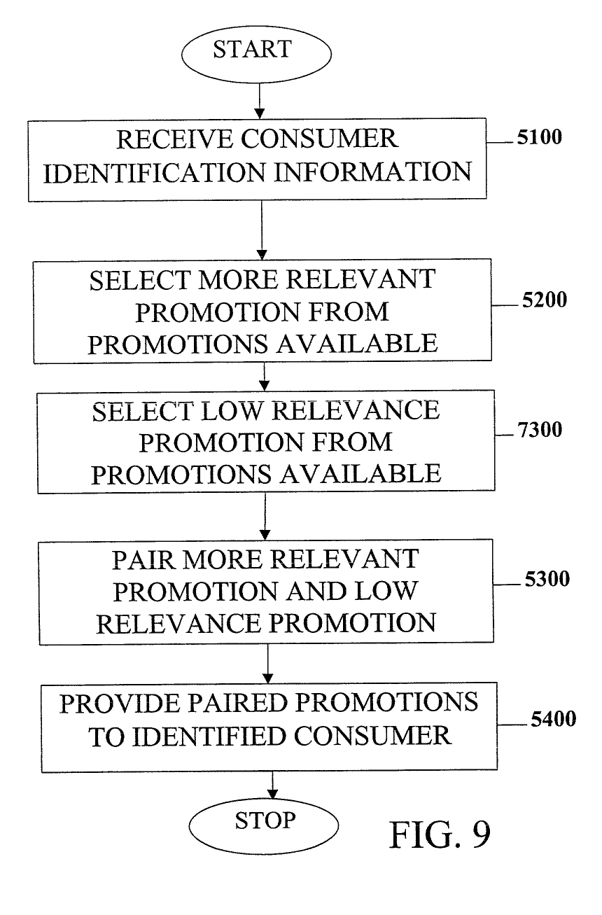

In FIG. 9, a method according to the present invention is performed in the absence of a predetermined low relevance promotion. In particular, once a consumer is identified (in step 5100) and a more relevant promotion selected (in step 5200), then a low relevance promotion is selected from the promotion storage table 613 in step 7300. Selecting a low relevance promotion in step 7300 can be done in a number of ways, including comparing a list of promotions that a promoter desires to be provided to “new” consumers with the demographic, purchase history, and/or promotion exercise history of the consumer identified in step 5100 to locate a consumer that has, e.g., demographic, purchase history, and/or promotion usage characteristics that indicate that the consumer may be likely to continue to purchase a product after the initial, low relevance promotion has been exercised. For example, even though a consumer has never purchased a breakfast cereal product, a consumer with a purchase history that indicates brand loyalty to a certain manufacturer may be a prime target for a low relevance promotion for the same manufacturer's breakfast cereal. Thus, by pairing more relevant promotion(s) for a commonly purchased product with a low relevance promotion for, e.g., breakfast cereal products from the same manufacturer, the likelihood that the consumer will exercise the low relevance promotion can be increased. Likewise, a female consumer with children and a purchase history that includes low fat products may be a prime target for a newly developed health food for children, even though the particular consumer has never before purchased the newly developed health food or any food in the particular product class. By pairing the low relevance promotion for the newly developed health food with a more relevant promotion that the female consumer has purchased in the past, the likelihood that the low relevance promotion is exercised can be increased. As another example, if a consumer frequently purchases ethnic entrees, such as Mexican food entrees, then a high value, more relevant promotion relating to Mexican food entrees paired with a low relevance promotion relating to a different product class, such as Mexican snack food, can be used to spur sales of the Mexican snack food when a particular supermarket location begins to stock the Mexican snack food.

Alternatively, the method illustrated in FIG. 9 can be useful to the practitioner of the present invention when the practitioner is paid on a per hit (per promotion exercised) basis. By pairing a low relevance promotion with a more relevant promotion, the total rate of redemption can be increased and the payment to the practitioner increased.

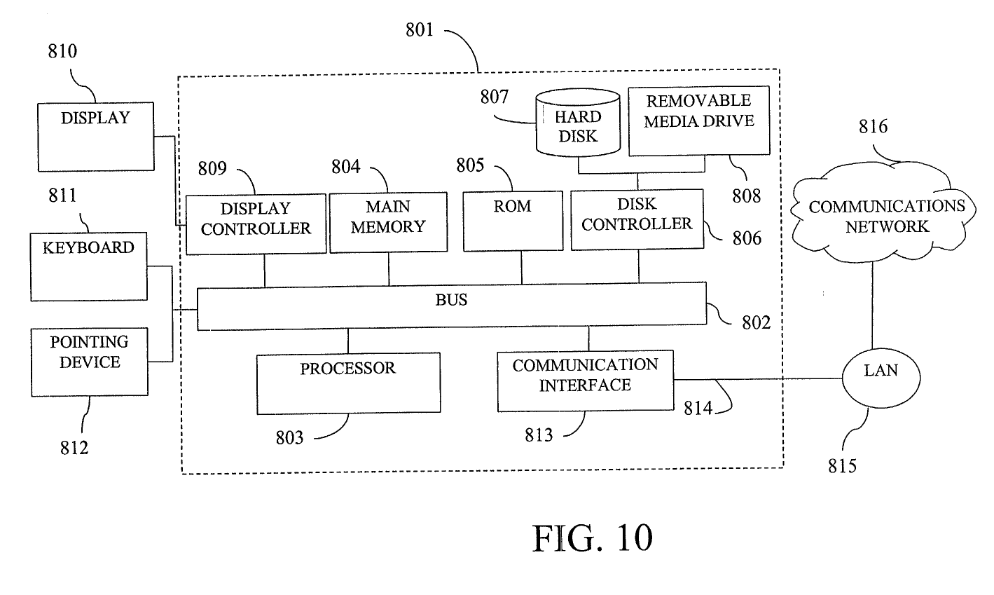

FIG. 10 illustrates a computer system 801 that can form several different units in an embodiment of the present invention. For example, computer system 801 can alternately form the central database system 610, a vendor interaction site 630, 640, or 650, or an other database system 660 of FIGS. 1 and 2. For this reason, the computer system 801 will be described using unique reference numerals. When a part of computer system 801 that is analogous to a part in another figure is described, this will be stated in the text. Computer system 801 includes a bus 802 or other communication mechanism for communicating information, and a processor 803 coupled with bus 802 for processing the information. Processor 803 can form processor 611 or 643 and/or one or more of the vendor terminals 632, 642, or 652 of FIGS. 1 and 2. Computer system 801 also includes a main memory 804, such as a random access memory (RAM) or other dynamic storage device (e.g., dynamic RAM (DRAM), static RAM (SRAM), synchronous DRAM (SDRAM), flash RAM), coupled to bus 802 for storing information and instructions to be executed by processor 803. In addition, main memory 804 may be used for storing temporary variables or other intermediate information during execution of instructions to be executed by processor 803. Computer system 801 further includes a read only memory (ROM) 805 or other static storage device (e.g., programmable ROM (PROM), erasable PROM (EPROM), and electrically erasable PROM (EEPROM)) coupled to bus 802 for storing static information and instructions for processor 803. A hard disk 807 and/or removable media drive 808, such as a i magnetic disk or optical disk, is provided and coupled to bus 802 by way of a disk controller 806 for storing information and instructions. Hard disk 807 and/or removable media drive 808 can contain the tables 613, 614, 615, 616, 617, and 618 of FIGS. 1 and 2.

The computer system 801 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or further fixed, high density media drives, may be added to the computer system 801 using an appropriate device bus (e.g., a small computer system interface (SCSI) bus, an enhanced integrated device electronics (IDE) bus, or an ultra-direct memory access (DMA) bus). Such removable media devices and fixed, high density media drives can also contain the tables 613, 614, 615, 616, 617, and 618 of FIGS. 1 and 2. The computer system 801 may additionally include a compact disc reader, a compact disc reader-writer unit, or a compact disc juke box, each of which may be connected to the same device bus or another device bus.

Computer system 801 may be coupled via bus 802 to a display 810, such as a cathode ray tube (CRT), for displaying information to a computer user. Display 810 can form a promotion and/or address output device 634 or 644 of FIGS. 1 and 2, especially when the vendor site is an individual's home computer and the paired promotions are advertisements. The display 810 may be controlled by a display or graphics card. The computer system includes input devices, such as a keyboard 811 and a pointing device 812 (e.g., a cursor control), for communicating information and command selections to processor 803. The keyboard 811 and a pointing device 812 (e.g., a cursor control) can form a promotion, identification, and/or request input device 636, 638, and/or 646 of FIGS. 1 and 2. The pointing device 812 (e.g., cursor control), for example, is a mouse, a trackball, or cursor direction keys for communicating direction information and command selections to processor 803 and for controlling cursor movement on the display 810. In addition, a printer (not shown) may provide a promotion and/or address output device 634 or 644 of FIGS. 1 and 2, especially wherein the paired promotions are paired coupons provided at the cashier of a supermarket.

The computer system 801 performs a portion or all of the processing steps of the invention in response to processor 803 executing one or more sequences of one or more instructions contained in a memory, such as the main hard disk memory 807. Such instructions may be read into the main hard disk memory 807 from another computer readable medium, such as removable media drive 808. Thus, either the main hard disk memory 807 or the removable media drive 808 can include the analysis tools table 618. One or more processors in a multi-processing arrangement may also be employed to execute the sequences of instructions contained in main hard disk memory 807. In alternative instructions. Thus, embodiments are not limited to any specific combination of hardware circuitry and software.

As stated above, the system 801 includes at least one computer readable medium or memory programmed according to the teachings of the invention and for storing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 801, for driving a device or devices for implementing the invention, and for enabling the computer system 801 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium or media that participate in providing instructions to processor 803 for execution. A computer readable medium may take many forms, including but not limited to, non-volatile media, volatile media, and transmission media. Non-volatile media includes, for example, optical, magnetic disks, and magneto-optical disks, such as hard disk 807 and/or removable media drive 808. Transmission media includes coaxial cables, copper wire and fiber optics, including the wires that comprise bus 802. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 801 may receive the data on the telephone line and use an infrared transmitter to convert the data to an infrared signal. An infrared detector coupled to bus 802 can receive the data carried in the infrared signal and place the data on bus 802. Bus 802 carries the data to main hard disk memory 807, from which processor 803 retrieves and executes the instructions. The instructions received by main hard disk memory 807 may optionally be stored on a removable media storage device 808 either before or after execution by processor 803.

Computer system 801 also includes a communication interface 813 coupled to bus 802. As described previously, communication interface 813 can itself form a promotion and/or address output device 634 and 644 when paired electronic promotions and/or address data are communicated electronically to another device such as a computer, cash register, credit-card billing device, coupon printer, etc. Such electronic promotions can include, for example, electronic codes automatically transmitted to the register of a vendor, electronic data describing an advertisement to a consumer's personal computer, or deductions from a customer's account upon purchase or order of a product. Communication interface 813 provides a two-way data communication coupling to a communications network 816 that is connected to a local network 815. For example, communication interface 813 may be a network interface card to attach to any packet switched local area network (LAN). As another example, communication interface 813 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 813 sends and receives electrical, electromagnetic or optical signals that carry digital data streams representing various types of information.

Communications network 816 typically provides data communication through one or more networks to other data devices. For example, communications network 816 may provide a connection to another computer (not shown) through local network 815 (e.g., a LAN) or through equipment operated by a service provider, which provides communication services through a communications network 816. Communications network 816 can form network 620 of FIGS. 1 and 2. According to one embodiment, computer 801 is one of the interactions sites 630 while central database system 610 is formed by another computer 801. In some embodiments, local network 815 and communications network 816 preferably use electrical, electromagnetic, or optical signals that carry digital data streams. The signals through the various networks and the signals on network link 814 and through communication interface 813, which carry the digital data to and from computer system 801, are exemplary forms of carrier waves transporting the information. Computer system 801 can transmit notifications and receive data, including program code, through the network(s), network link 814 and communication interface 813.

Obviously, numerous modifications and variations of the present invention are possible in light of the above teachings. It is therefore to be understood that within the scope of the appended claims, the invention may be practiced otherwise than as specifically described herein.

1. A computer-implemented method for increasing the likelihood that a first low relevance promotion will be exercised by a consumer, comprising:
receiving identification information from said consumer;
determining a category purchase history of said consumer using said received identification information;
selecting a second promotion determined to be more relevant to said consumer identified by said identification information based upon said category purchase history of said consumer; and
pairing said first low relevance promotion with said second promotion.

2. The computer-implemented method according to claim 1, wherein said category purchase history comprises a frequency of purchases in a product category.

3. The computer-implemented method according to claim 1, wherein said category purchase history comprises a number of purchases in a product category.

4. A computer-implemented method for increasing the likelihood that a first low relevance promotion will be exercised by a consumer, comprising:
receiving identification information from said consumer;
determining a promotion usage denominator of said consumer using said received identification information;
selecting a second promotion determined to be more relevant to said consumer identified by said identification information based upon said promotion usage denominator of said consumer; and
pairing said first low relevance promotion with said second promotion.

5. The computer-implemented method according to claim 4, wherein said promotion usage denominator relates to a value of promotions exercised by said consumer.

6. The computer-implemented method according to claim 4, wherein said promotion usage denominator relates to a location where promotions are exercised by said consumer.

7. A computer-implemented method for increasing the likelihood that a first low relevance promotion will be exercised by a consumer, comprising:
receiving identification information from said consumer;
determining a demographic characteristic of said consumer using said received identification information;
selecting a second promotion determined to be more relevant to said consumer identified by said identification information based upon said demographic characteristic of said consumer; and
pairing said first low relevance promotion with said second promotion.

8. The computer-implemented method according to claim 7, wherein said demographic characteristic of said consumer comprises a pet ownership by said consumer.

9. The computer-implemented method according to claim 7, wherein said demographic characteristic of said consumer comprises parenthood.

10. The computer-implemented method according to any one of claims 1, 4, or 7, further comprising providing said paired first low relevance promotion and second promotion to said consumer.

11. The computer-implemented method according to any one of claims 1, 4, or 7, wherein said pairing step comprises printing said first low relevance promotion and said second promotion on a sheet of paper.

12. The computer-implemented method according to any one of claims 1, 4, or 7, wherein said first low relevance promotion and said second promotion are in a packaged goods industry.

13. The computer-implemented method according to any one of claims 1, 4, or 7, wherein said first low relevance promotion and said second promotion are for goods from a same promoter.

14. The computer-implemented method according to any one of claims 1, 4, or 7, wherein said first low relevance promotion and said second promotion are for goods from different promoters.

15. The computer-implemented method according to any one of claims 1, 4, or 7, wherein said first low relevance promotion is for a new product.

16. The computer-implemented method according to any one of claims 1, 4, or 7, wherein said new product is new to a store.

17. The computer-implemented method according to any one of claims 1, 4, or 7, wherein said new product is new to said consumer.

18. The computer-implemented method according to any one of claims 1, 4, or 7, wherein said new product is newly developed.

19. The computer-implemented method according to any one of claims 1, 4, or 7, further comprising:
selecting a third promotion determined to be more relevant to said consumer identified by said identification information; and
pairing said third promotion with said first low relevance promotion and said second promotion.

20. A system for increasing the likelihood that a first low relevance promotion will be exercised by a consumer, comprising:
means for receiving identification information from said consumer;
means for determining a category purchase history of said consumer using said identification information received from said means for receiving;
means for selecting a second promotion determined to be more relevant to said consumer identified by said identification information based upon said category purchase history of said consumer; and
means for pairing said first low relevance promotion with said second promotion.

21. A system for increasing the likelihood that a first low relevance promotion will be exercised by a consumer, comprising:
an identification input device configured to receive identification information from said consumer;
a category purchase history database including a category purchase history of said consumer, said category purchase history queried by said received identification information;
a potential second promotion database including a plurality of potential second promotions; and
a processor configured to select a second promotion having a high relevance to said consumer from said plurality of potential second promotions based on said category purchase history and to pair said second promotion with said first low relevance promotion.

22. A system for increasing the likelihood that a first low relevance promotion will be exercised by a consumer, comprising:
means for receiving identification information from said consumer;
means for determining a promotion usage denominator of said consumer using said identification information received by said means for receiving;
means for selecting a second promotion determined to be more relevant to said consumer identified by said identification information based upon said promotion usage denominator of said consumer; and
means for pairing said first low relevance promotion with said second promotion.

23. A system for increasing the likelihood that a first low relevance promotion will be exercised by a consumer, comprising:
an identification input device configured to receive identification information from said consumer;
a promotion usage database including a promotion usage denominator of said consumer, said promotion usage denominator queried by said received identification information;
a potential second promotion database including a plurality of potential second promotions; and
a processor configured to select a second promotion having a high relevance to said consumer from said plurality of potential second promotions based on said promotion usage denominator and to pair said second promotion with said first low relevance promotion.

24. A system for increasing the likelihood that a first low relevance promotion will be exercised by a consumer, comprising:
means for receiving identification information from said consumer;
means for determining a demographic characteristic of said consumer using said identification information received by said means for receiving;
means for selecting a second promotion determined to be more relevant to said consumer identified by said identification information based upon said demographic characteristic of said consumer; and
means for pairing said first low relevance promotion with said second promotion.

25. A system for increasing the likelihood that a first low relevance promotion will be exercised by a consumer, comprising:
an identification input device configured to receive identification information from said consumer;
a demographic database including a demographic characteristic of said consumer, said demographic characteristic queried by said received identification information;
a potential second promotion database including a plurality of potential second promotions; and
a processor configured to select a second promotion having a high relevance to said consumer from said plurality of potential second promotions based on said demographic characteristic and to pair said second promotion with said first low relevance promotion.

26. A computer-implemented method for increasing the likelihood that a first low relevance promotion will be exercised, comprising:
receiving promotion information regarding said first low relevance promotion and a second promotion;
pairing said first low relevance promotion with said second promotion;
identifying a consumer likely to exercise said second promotion;
providing said consumer with said paired first low relevance promotion and second promotion.

27. A computer readable medium containing program instructions for execution on a computer system, which when executed by the computer system, cause the computer system to perform the method recited in any one of claims 1 to 9 and 26.
